(19) United States
(12) Patent Application Publication
(10) Pub. No.: US 2011/0241983 A1
(43) Pub. Date: Oct. 6, 2011

(54) DISPLAY DEVICE WITH PRIVACY FUNCTION, AND METHOD FOR PROVIDING PRIVACY TO A DISPLAY DEVICE

(76) Inventor: Yao-Tsung Chang, New Taipei City (TW)

(21) Appl. No.: 13/035,079

(22) Filed: Feb. 25, 2011

(30) Foreign Application Priority Data
Apr. 2, 2010 (TW) 099110345

(51) Int. Cl. G09G 5/00; G02B 27/02; G09F 13/04; G09G 5/10

(52) U.S. Cl. 345/156; 359/613; 362/97.1; 345/690; 345/102

(57) ABSTRACT

A method is adapted for providing privacy to a display device. The display device is adapted to display a normal image that can be viewed in a user area within which a user is situated. The method includes the steps of: a) configuring the display device to generate information of an interference image; b) configuring a display panel of the display device to display the normal image and the interference image; and c) configuring the display device to direct the interference image toward areas outside the user area. Accordingly, the user situated in the user area is able to view the normal image, while a viewer outside the user area is able to view the interference image, thereby achieving a privacy effect.

### CROSS-REFERENCE TO RELATED APPLICATION

This application claims priority of Taiwanese Application No. 099110345, filed on Apr. 2, 2010.

### BACKGROUND OF THE INVENTION

1. Field of the Invention

The present invention relates to a method for providing privacy to a display device, more particularly to a method that utilizes an interference image to provide privacy to a display device.

2. Description of the Related Art

Display devices are widely used in many applications, such as notebook computers, cell phones, digital cameras, personal digital assistants, and so on. When the display devices are used, how to prevent information displayed by the display device from being viewed by other people is a significant problem.

In a conventional method for providing privacy to a display device, a shield is attached to a display panel of the display device. By virtue of an optical film of the shield, a viewing region of the display panel is limited to a certain area at which a user may see an image displayed by the display panel such that other people situated in other areas outside the certain area may not see the image. Alternatively, the liquid crystal of the display device is controllable to block backlight of the display device such that, aside from an expected area at which an image displayed by the display device is viewable, the image may not be viewed at other areas. It is desirable to provide other methods for providing privacy to a display device.

### SUMMARY OF THE INVENTION

Therefore, an object of the present invention is to provide a method for providing privacy to a display device.

Accordingly, a method of the present invention is adapted for providing privacy to a display device. The display device is adapted to display a normal image that can be viewed in a user area within which a user is situated. The method comprises the steps of: a) configuring the display device to generate information of an interference image; b) configuring a display panel of the display device to display the normal image and the interference image; and c) configuring the display device to direct the interference image toward areas outside the user area.

Preferably, in step b), a part of picture elements of the display panel of the display device is controllable to operate as display pixels for displaying the normal image, and a remaining part of the picture elements of the display panel is controllable to operate as interference pixels for displaying the interference image. In step c), an optical path control component is configured to direct lights emitted from the interference pixels away from the user area and toward the areas outside the user area such that a viewer situated outside the user area is able to view the interference image.

Preferably, the optical path control component is configured to block optical paths of the lights emitted from the interference pixels toward the user area and to direct the lights emitted from the interference pixels away from the user area and toward the areas outside the user area. Particularly, the optical path control component is formed with a plurality of light-transmissive parts and a plurality of opaque parts, and a line connecting one of the interference pixels and a corresponding one of the opaque parts extends to the user area. The light-transmissive parts permit passage of lights emitted from the display pixels toward the user area, whereas the opaque parts block passage of the lights emitted from the interference pixels toward the user area. Further, the display device is configured to adjust positions of the light-transmissive parts and the opaque parts of the optical path control component according to a position of the user as detected by a detector of the display device. Particularly, the display device is configured to determine a relative position of the user with respect to the display device via the detector, and to adjust the positions of the light-transmissive parts and the opaque parts of the optical path control component according to the relative position. Therefore, when the user moves, the positions of the light-transmissive parts and the opaque parts are adjusted such that the viewer situated outside the user area continues to view the interference image.

Alternatively, the optical path control component is configured to refract and direct the lights emitted from the interference pixels toward the areas outside the user area.

Preferably, in step b), the display panel of the display device is configured to alternately display the normal image and the interference image. In step c), the display device is configured to direct the normal image toward the user area when the display panel displays the normal image, and to direct the interference image toward the areas outside the user area when the display panel displays the interference image such that a viewer situated outside the user area is able to view the interference image. Particularly, for directing the normal image toward the user area and directing the interference image toward the areas outside the user area, a backlight module of the display device includes a first light source configured to project light such that the normal image is directed at least toward the user area, and a second light source configured to project light such that the interference image toward the areas outside the user area.

Another object of the present invention is to provide a display device with privacy function.

According to another aspect, a display device of the present invention is adapted for displaying a normal image that can be viewed in a user area within which a user is situated. The display device comprises a display panel, a display control module, and an optical path control component. The display panel includes a plurality of picture elements for image display. The display control module is electrically connected to the display panel, and is operable to generate information of an interference image, to control a part of the picture elements of the display panel to operate as display pixels for displaying the normal image, and to control a remaining part of the picture elements of the display panel to operate as interference pixels for displaying the interference image. The optical path control component is disposed to correspond to the picture elements of the display panel so as to control optical paths of lights emitted from the interference pixels and to direct the lights emitted from the interference pixels toward areas outside the user area.

Preferably, the display pixels for displaying the normal image and the interference pixels for displaying the interference image are alternately arranged in one of vertical columns, horizontal rows, and an interlaced arrangement.

Preferably, the optical path control component is a lenticular lens that is disposed on the display panel, and that includes a plurality of first column parts registered with the interference pixels, and a plurality of second column parts registered with the display pixels. The first column parts are configured to refract and direct the lights emitted from the interference pixels toward the areas outside the user area, whereas the second column parts are configured to direct lights emitted from the display pixels toward the user area.

Preferably, the optical path control component is a liquid crystal shutter disposed in front of and spaced apart from the display panel. The liquid crystal shutter is formed with a plurality of light-transmissive parts permitting passage of lights emitted from the display pixels toward the user area, and a plurality of opaque parts blocking passage of the lights emitted from the interference pixels toward the user area. The display device further comprises a detector and a position-adjusting module. The detector is operable to detect a position of the user. The position-adjusting module cooperates with the detector to determine a relative position of the user with respect to the display device, and is operable to adjust positions of the light-transmissive parts and the opaque parts of the optical path control component according to the relative position so as to permit the passage of the lights emitted from the display pixels toward the user area and to block the passage of the lights emitted from the interference pixels toward the user area.

Preferably, the optical path control component is a parallax barrier plate disposed in front of and spaced apart from the display panel. The parallax barrier plate is formed with a plurality of light-transmissive parts permitting passage of lights emitted from the display pixels toward the user area, and a plurality of opaque parts blocking passage of the lights emitted from the interference pixels toward the user area.

According to a further aspect, a display device of this invention is adapted for displaying a normal image that can be viewed in a user area within which a user is situated. The display device comprises a display panel, a backlight module, and a display control module. The display panel is adapted for image display. The backlight module is disposed to correspond in position to the display panel, and includes a first light source and a second light source. The first light source is configured to provide the display panel with light such that an image displayed by the display panel is directed at least toward the user area and is viewable at the user area. The second light source is configured to provide the display panel with light such that the image displayed by the display panel is directed toward and is viewable at areas outside the user area. The display control module is electrically connected to the display panel and the backlight module. The display control module is operable to generate information of an interference image, to control the display panel to alternately display the normal image and the interference image, to turn on the first light source and turn off the second light source when the display panel displays the normal image, and to turn on the second light source and turn off the first light source when the display panel displays the interference image.

Preferably, the display panel is a liquid crystal panel.

According to this invention, a user situated within a user area is able to view a normal image and not view an interference image, whereas a viewer situated outside the user area is able to view the interference image, thereby resulting in a privacy effect.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view for illustrating relationship between positions of a user area relative to a display device implementing a first preferred embodiment of a method for providing privacy according to this invention, and an interference area;

FIG. 2 is a schematic view for illustrating components of the display device;

FIG. 3 is a block diagram for illustrating hardware architecture of the display device;

FIG. 4 is a flow chart for illustrating steps of the method of the first preferred embodiment;

FIG. 5 is a fragmentary schematic view for illustrating picture elements of a display panel of the display device operating as display pixels and interference pixels;

FIG. 6 is a fragmentary schematic view for illustrating a function of an optical path control component of the display device;

FIG. 7 is a fragmentary schematic view for illustrating that positions of light-transmissive parts and opaque parts of the optical path control component are movable when a user moves;

FIG. 8 is a schematic view for illustrating a display device implementing a second preferred embodiment of a method for providing privacy according to this invention;

FIG. 9 is a block diagram for illustrating hardware architecture of the display device;

FIG. 10 is a fragmentary schematic view for illustrating a function of an optical path control component of the display device;

FIG. 11 is a flow chart for illustrating steps of the method of the second preferred embodiment;

FIG. 12 is a schematic view for illustrating a display device implementing a third preferred embodiment of a method for providing privacy according to this invention, and for illustrating that an image displayed by the display device is directed toward a user area;

FIG. 13 is a schematic view for illustrating that an image displayed by the display device is directed toward areas outside the user area;

FIG. 14 is a block diagram for illustrating hardware architecture of the display device; and

FIG. 15 is a flow chart for illustrating steps of the method of the third preferred embodiment.

### DETAILED DESCRIPTION OF THE PREFERRED EMBODIMENTS

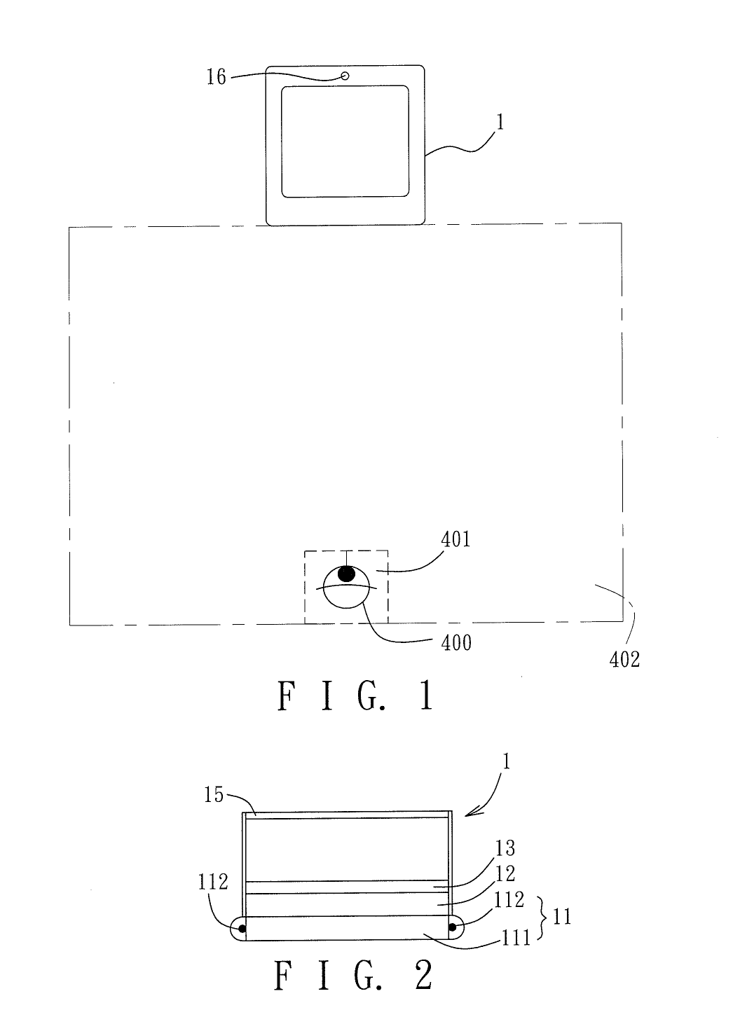

Referring to FIG. 4, a first preferred embodiment of a method for providing privacy to a display device is implemented by a display device 1 shown in FIGS. 1 to 3. The display device 1 includes a control unit 10, a backlight module 11, an optical layer 12, a display panel 13, a memory unit 14, an optical path control component 15, and a detector 16. As shown in FIG. 2, the backlight module 11, the optical layer 12 and the display panel 13 are stacked in sequence from rear to front, and the optical path control component 15 is disposed in front of and spaced apart from the display panel 13. The optical path control component 15 is controlled by the control unit 10 so as to adjust a viewing angle of the display panel 13. The control unit 10 is operable to read the memory unit 14 and control the display panel 13 to display an image, and is coupled to and cooperates with the detector 16 to adjust the optical path control component 15. For convenience of the following description, in this embodiment, an area within which a user 400 is situated is defined as a user area 401, and an area outside the user area 401 is defined as an interference area 402. Further, the user area 401 and the interference area 402 may move when the user 400 moves.

The backlight module 11 includes a light-guiding plate 111 and a pair of light sources 112 respectively disposed at opposite sides of light-guiding plate 111. In this embodiment, the light sources 112 are cold cathode lamps. It should be noted that the backlight module 11 is not limited to this embodiment and may be other types of backlight modules, such as a light-emitting-diode backlight module. The optical layer 12 is disposed on the backlight module 11, and maybe one of a brightness enhancement film, a prismoidal lens, and a diffusion plate. Further, in other embodiments, the display device 1 may include a plurality of the optical layers 12, or the optical layer 12 may even be omitted.

The display panel 13 is disposed on the optical layer 12, and includes a plurality of picture elements for image display. In this embodiment, the display panel 13 is a liquid crystal panel. However, the display panel 13 may be a plasma panel or an organic light-emitting display panel that do not require the backlight module 11. The memory unit 14 stores information of a normal image, and provides the control unit 10 with required memory space. In this embodiment, the memory unit 14 is a dynamic random access memory (DRAM).

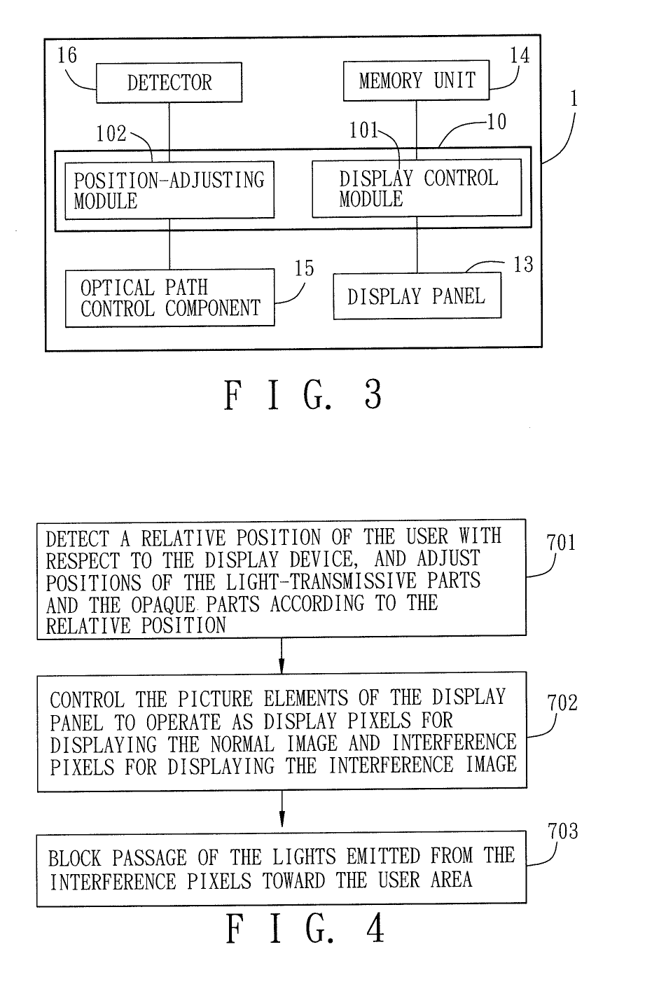

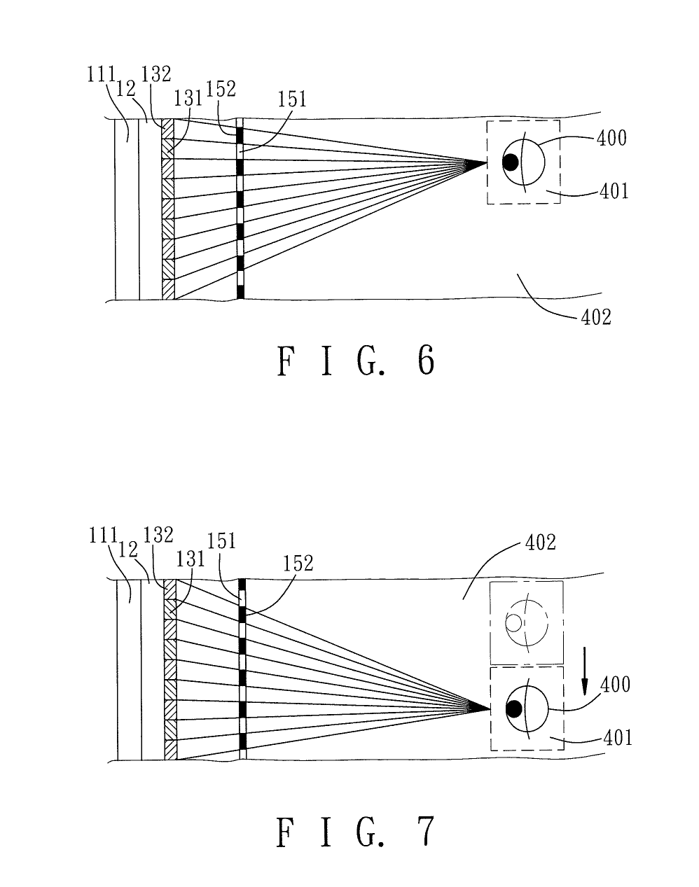

Referring to FIGS. 1 and 3, the detector 16 is operable to detect a position of the user 400 for determining the user area 401. In particular, the detector 16 may be a charge-coupled device (CCD) or a CMOS image sensor (CIS), and is adapted to capture an image of the user 400 and to transmit information of the captured image of the user 400 to the control unit 10. The control unit 10 includes a position-adjusting module 102 electrically connected to the detector 16 and the optical path control component 15. The position-adjusting module 102 is adapted to receive the information of the image captured by the detector 16, and to implement image processing for determining a relative position of the user 400 with respect to the display device 1 so as to identify the user area 401 associated with the user 400. Referring to FIG. 6, the optical path control component 15 is formed with a plurality of light-transmissive parts 151 and a plurality of opaque parts 152, and the position-adjusting module 102 is operable to adjust positions of the light-transmissive parts 151 and the opaque parts 152 according to the relative position of the user 400 in step 701 shown in FIG. 4. The function of the optical path control component 15 will be described later. In this embodiment, the control unit is a microprocessor, and the position-adjusting module 102 may be implemented using software. In other embodiments, the control unit 10 and the position-adjusting module 102 may be implemented using electronic circuits.

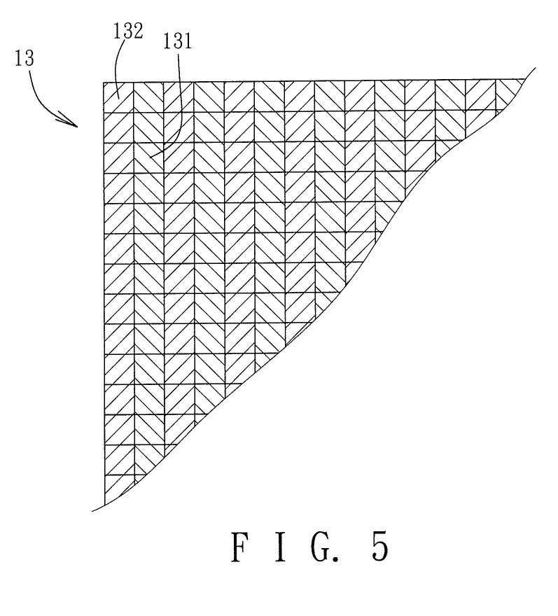

The control unit 10 further includes a display control module 101 electrically connected to the memory unit 14 and the display panel 13 as shown in FIG. 3. In this embodiment, the display control module 101 may be implemented using software or electronic circuits. The display control module 101 is operable to generate information of an interference image. In step 702 shown in FIG. 4, the display control module 101 is operable to control a part of the picture elements of the display panel 13 to operate as display pixels 131 for displaying the normal image according to the information stored in the memory unit 14, and to control a remaining part of the picture elements of the display panel 13 to operate as interference pixels 132 for displaying the interference image. In particular, as shown in FIG. 5, the display control module 101 is operable to set the picture elements in odd vertical columns as the display pixels 131, and to set the picture elements in the even vertical columns as the interference pixels 132. That is to say, the picture elements in the odd vertical columns are used for displaying the normal image, and the picture elements in the even vertical columns are used for displaying the interference image. Certainly, the display pixels 131 and the interference pixels 132 may be alternately arranged in horizontal rows or in an interlaced arrangement in other embodiments.

It should be noted that, in this embodiment, the optical path control component 15 is a liquid crystal shutter formed with the light-transmissive parts 151 and the opaque parts 152 as shown in FIG. 6. Particularly, a line connecting one of the interference pixels 132 and a corresponding one of the opaque parts 152 extends to the user area 401. In step 703 as shown in FIG. 4, lights emitted from the interference pixels 132 are blocked by the opaque parts 152, that is to say, the opaque parts 152 block passage of the lights emitted from the interference pixels 132 toward the user area 401. Therefore, the interference image will not be directed toward the user area 401. Furthermore, the light-transmissive parts 151 permit passage of lights emitted from the display pixels 131 toward the user area 401. Thus, the user 400 situated within the user area 401 may see the normal image but not the interference image, and other people within the interference area 402 may see the interference image and be disturbed thereby. Accordingly, an effect of providing privacy is achieved.

Additionally, referring to FIG. 7, when the position-adjusting module 102 cooperates with the detector 16 to determine that the position of the user 401 has changed, the position-adjusting module 102 is operable to adjust positions of the light-transmissive parts 151 and the opaque parts 152 according to the relative position of the user 400 with respect to the display device 1. That is to say, the positions of the light-transmissive parts 151 and the opaque parts 152 are adjustable according to the position of the user 400 detected by the detector 16. Therefore, the light-transmissive parts 151 may still accurately permit the passage of the lights emitted from the display pixels 131 toward the user area 401 and direct the normal image to the user area 401, and the opaque parts 152 may still block the passage of the lights emitted from the interference pixels 132 toward the user area 401. As a result, no matter where the user 400 is situated, the user 400 may only see the normal image but not the interference image. Further, since the interference image displayed by the interference pixels 132 is still directed to the interference area 402 outside the user area 401, the interference image still interferes with the people within the interference area 402 to thereby maintain the effect of providing privacy. Moreover, an ultrasonic detector or an infrared detector may be used for detecting the position of the user 400 so as to determine the relative position of the user 400 with respect to the display device 1 in other embodiments.

Additionally, the memory unit 14 may be configured to store both the information of the normal image and the information of the interference image such that the display control module 101 is operable to control the display pixels 131 and the interference pixels 132 to display the normal image and the interference image according to the information stored in the memory unit 14, respectively. Further, the optical path control component 15 may alternatively be a parallax barrier plate. It should be noted that, while the positions of the light-transmissive parts 151 and the opaque parts 152 formed on the liquid crystal shutter are adjustable, the positions of the light-transmissive parts 151 and the opaque parts 152 formed on the parallax barrier plate are not adjustable.

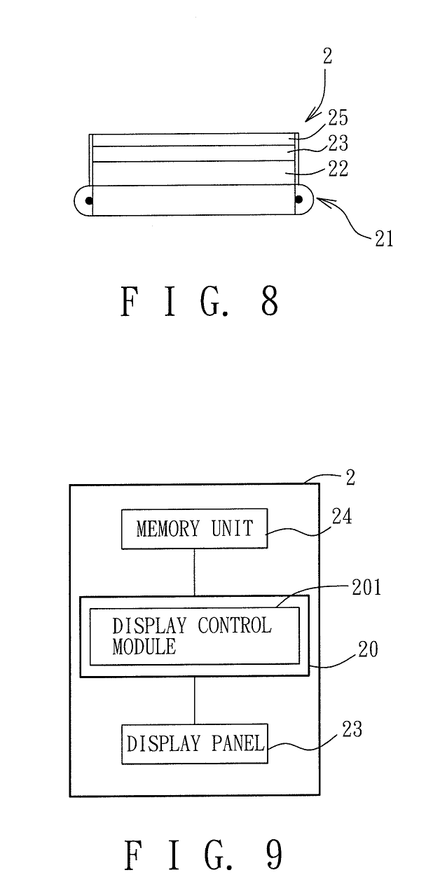

Referring to FIG. 11, a second preferred embodiment of a method for providing privacy to a display device is implemented by a display device 2 shown in FIGS. 8 to 10. The display device 2 includes a control unit 20, a backlight module 21, an optical layer 22, a display panel 23, a memory unit 24, and an optical path control component 25. The backlight module 21, the optical layer 22, the display panel 23 and the memory unit 24 are similar to the backlight module 11, the optical layer 12, the display panel 13 and the memory unit 14 of the display device 1 described in the first preferred embodiment. It should be noted that the optical path control component 25 of the display device 2 of this embodiment is not adjustable, and thus the user area 401 associated with the display device 2 within which the user 400 may see the normal image is immovable. That is to say, a viewing angle of the display device 2 for displaying the normal image is constant. The viewing angle is associated with the user area 401, and an area outside the viewing angle is the interference area 402, i.e., a viewing angle of the display device 2 for displaying the interference image.

Compared with the first preferred embodiment, the control unit 20 of the display device 2 of the second preferred embodiment only includes a display control module 201. In this embodiment, the control unit 20 is a microprocessor, and the display control module 201 maybe implemented using software or electronic circuits.

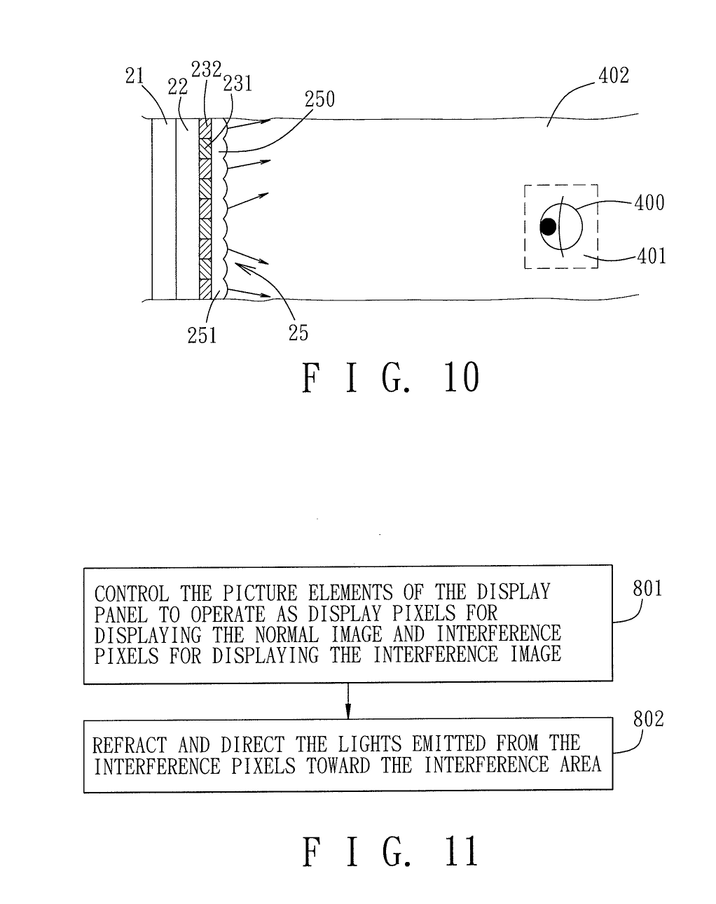

In step 801 of the flowchart shown in FIG. 11, the display control module 201 is operable to control apart of the picture elements of the display panel 23 to operate as display pixels 231, and to control a remaining part of the picture elements of the display panel 23 to operate as interference pixels 232 as shown in FIG. 10. Arrangement of the display pixels 231 and the interference pixels 232 is similar to the arrangement of the display pixels 131 and the interference pixels 132 of the first preferred embodiment shown in FIG. 5. In particular, the display control module 201 in this embodiment is operable to set the picture elements of the display panel 23 in odd vertical columns as the display pixels 231, and to set the picture elements of the display panel 23 in the even vertical columns as the interference pixels 232.

Referring to FIG. 10, the optical path control component 25 in this embodiment is a lenticular lens formed with a plurality of first column parts 251 registered with the interference pixels 232, and a plurality of second column parts 250 registered with the display pixels 231. In step 802 of the flowchart shown in FIG. 11, the second column parts 250 are configured to direct lights emitted from the display pixels 231 toward the user area 401, and the first column parts 251 are configured to refract and direct lights emitted from the interference pixels 232 toward the interference area 402. Optical structure of the optical path control component 25 is configured to refract the lights emitted from the interference pixels 232 and originally directed toward the user area 401, and to direct the interference image to the interference area 402. Therefore, the user 400 situated within the user area 401 may only see the normal image, and people situated within the interference area 402 may see the interference image and be disturbed thereby. Accordingly, an effect of providing privacy is achieved.

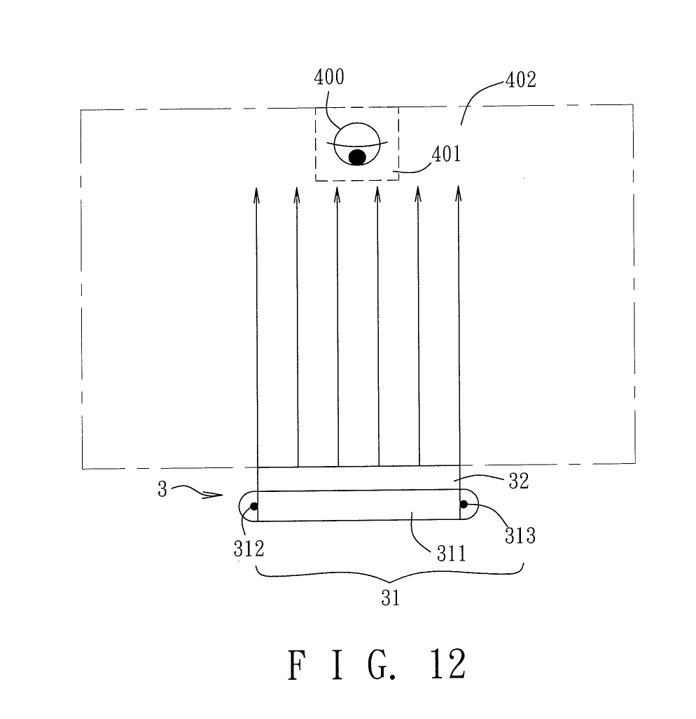

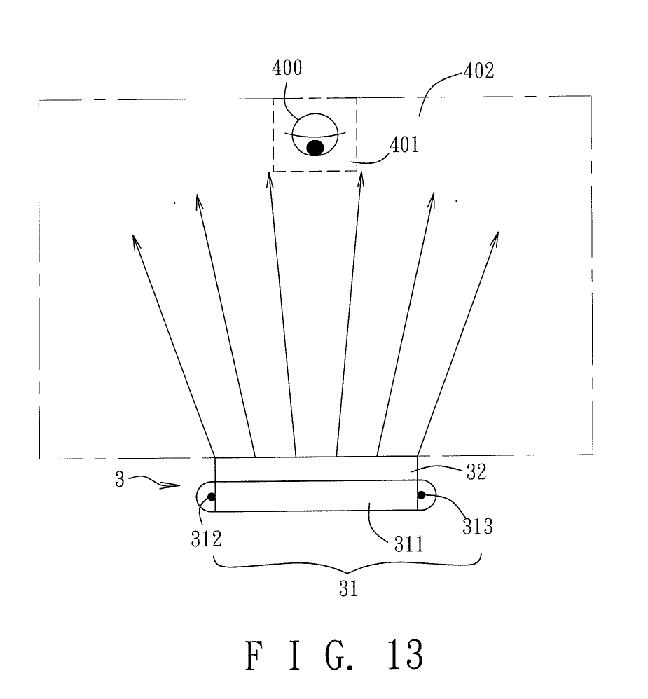

Referring to FIG. 15, a third preferred embodiment of a method for providing privacy to a display device is implemented by a display device 3 shown in FIGS. 12 to 14. The display device 3 includes a control unit 30, a backlight module 31, a display panel 32, and a memory unit 33. The memory unit 33 in this embodiment is similar to the memory unit 14 of the display device 1 of the first preferred embodiment, and details thereof will be omitted herein for the sake of brevity.

The display panel 32 is adapted for displaying an image. In this embodiment, the display panel 32 is a liquid crystal panel. The backlight module 31 is stackedly disposed to correspond in position to the display panel 32 so as to provide backlight to the display panel 32 for displaying images. In this embodiment, the backlight module 31 is a directional backlight module, and includes an optical light-guiding plate 311, a first light source 312 disposed at one side of the optical light-guiding plate 311, and a second light source 313 disposed at the other side of the optical light-guiding plate 311. Techniques of the directional backlight module are disclosed in Taiwanese Patent No. I312883, and details thereof will be omitted herein for the sake of brevity. By the design of the optical light-guiding plate 311, when the first light source 312 is turned on and the second light source 313 is turned off, lights emitted from the display device 3 will be directed toward the user area 401 as shown in FIG. 12. When the second light source 313 is turned on and the first light source 312 is turned off, the lights emitted from the display device 3 will be directed toward the interference area 401 as shown in FIG. 13.

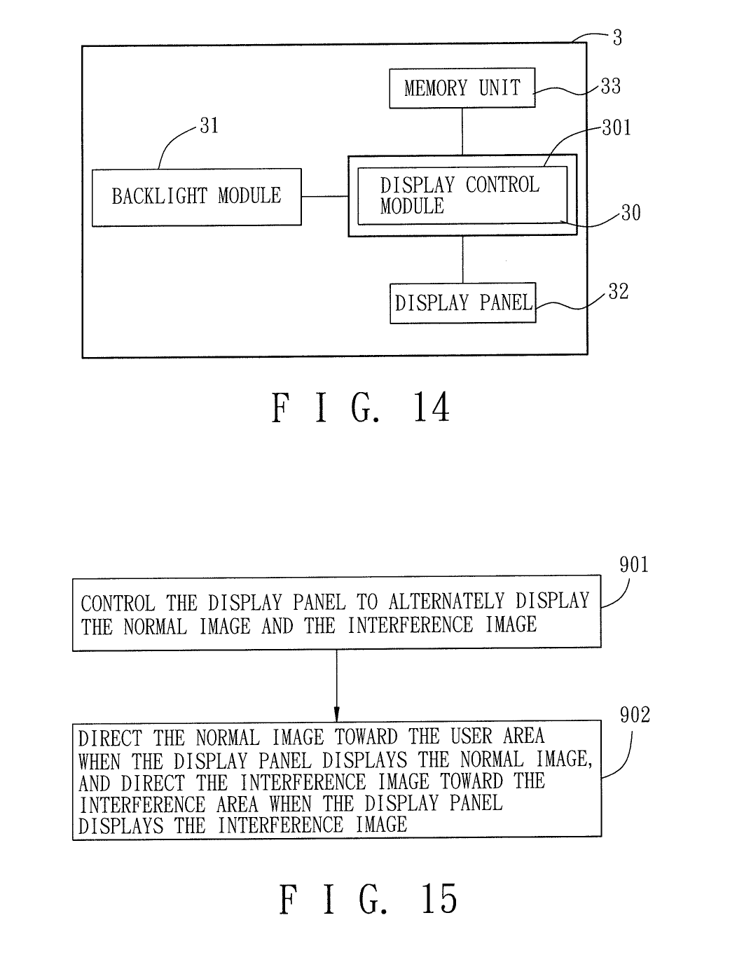

Referring to FIG. 14, the control unit 30 includes a display control module 301 electrically connected to the memory unit 33, the display panel 32 and the backlight module 31. In this embodiment, the control unit 30 is a microprocessor, and the display control module 301 may be implemented using software or electronic circuits. In step 901 of the flowchart shown in FIG. 15, the display control module 301 is operable to generate information of an interference image, and to control the display panel 32 to alternately display the normal image and the interference image. Further, in step 902, when inputting the information of the normal image to the display panel 32 for displaying the normal image, the display control module 301 is operable to control the backlight module 31 to turn on the first light source 312 and turn off the second light source 313 so as to direct the normal image toward the user area 401 as shown in FIG. 12. On the other hand, when inputting the information of the interference image to the display panel 32 for displaying the interference image, the display control module 301 is operable to control the backlight module 31 to turn on the second light source 313 and turn off the first light source 312 so as to direct the interference image toward the interference area 402 as shown in FIG. 13. Therefore, by directing the interference image toward the interference area 402, people situated within the interference area 402 will see the interference image and be disturbed thereby, and thus an effect of providing privacy is achieved.

In summary, the display device 1, 2, 3 of this invention is adapted to generate the interference image. By the above-mentioned steps and components, the display device 1, 2, 3 allows the user 400 situated within the user area 401 to see the normal image but not the interference image, and makes people situated within the interference area 402 see the interference image. Therefore, the people situated within the interference area 402 will be disturbed by the interference image to thereby achieve an effect of providing privacy to the display device 1, 2, 3.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display device for displaying a normal image that can be viewed in a user area within which a user is situated, said display device comprising:
a display panel including a plurality of picture elements for image display;
a display control module electrically connected to said display panel, said display control module being operable to generate information of an interference image, to control a part of said picture elements of said display panel to operate as display pixels for displaying the normal image, and to control a remaining part of said picture elements of said display panel to operate as interference pixels for displaying the interference image; and
an optical path control component disposed to correspond to said picture elements of said display panel so as to control optical paths of lights emitted from said interference pixels and to direct the lights emitted from said interference pixels toward areas outside the user area.

2. The display device as claimed in claim 1, wherein said display pixels for displaying the normal image and said interference pixels for displaying the interference image are alternately arranged in one of vertical columns, horizontal rows, and an interlaced arrangement.

3. The display device as claimed in claim 2, wherein said optical path control component is a lenticular lens that is disposed on said display panel, and that includes:
a plurality of first column parts registered with said interference pixels and configured to refract and direct the lights emitted from said interference pixels toward the areas outside the user area; and
a plurality of second column parts registered with said display pixels and configured to direct lights emitted from said display pixels toward the user area.

4. The display device as claimed in claim 2, wherein said optical path control component is a liquid crystal shutter that is disposed in front of and spaced apart from said display panel, and that is formed with a plurality of light-transmissive parts permitting passage of lights emitted from said display pixels toward the user area, and a plurality of opaque parts blocking passage of the lights emitted from said interference pixels toward the user area.

5. The display device as claimed in claim 4, further comprising:
a detector operable to detect a position of the user; and
a position-adjusting module cooperating with said detector to determine a relative position of the user with respect to said display device, and being operable to adjust positions of said light-transmissive parts and said opaque parts of said optical path control component according to the relative position so as to permit the passage of the lights emitted from said display pixels toward the user area and to block the passage of the lights emitted from said interference pixels toward the user area.

6. The display device as claimed in claim 2, wherein said optical path control component is a parallax barrier plate that is disposed in front of and spaced apart from said display panel, and that is formed with a plurality of light-transmissive parts permitting passage of lights emitted from said display pixels toward the user area, and a plurality of opaque parts blocking passage of the lights emitted from said interference pixels toward the user area.

7. A display device for displaying a normal image that can be viewed in a user area within which a user is situated, said display device comprising:
a display panel for image display;
a backlight module disposed to correspond in position to said display panel, said backlight module including
a first light source configured to provide said display panel with light such that an image displayed by said display panel is directed at least toward the user area and is viewable at the user area, and
a second light source configured to provide said display panel with light such that the image displayed by said display panel is directed toward and is viewable at areas outside the user area; and
a display control module electrically connected to said display panel and said backlight module, said display control module being operable to generate information of an interference image, to control said display panel to alternately display the normal image and the interference image, to turn on said first light source and turn off said second light source when said display panel displays the normal image, and to turn on said second light source and turn off said first light source when said display panel displays the interference image.

8. The display device as claimed in claim 7, wherein said display panel is a liquid crystal panel.

9. A method for providing privacy to a display device, the display device being adapted to display a normal image that can be viewed in a user area within which a user is situated, said method comprising the steps of:
a) configuring the display device to generate information of an interference image;
b) configuring a display panel of the display device to display the normal image and the interference image; and
c) configuring the display device to direct the interference image toward areas outside the user area.

10. The method as claimed in claim 9, wherein:
in step b), a part of picture elements of the display panel of the display device is controllable to operate as display pixels for displaying the normal image, and a remaining part of the picture elements of the display panel is controllable to operate as interference pixels for displaying the interference image; and
in step c), an optical path control component is configured to direct lights emitted from the interference pixels away from the user area and toward the areas outside the user area such that a viewer situated outside the user area is able to view the interference image.

11. The method as claimed in claim 10, wherein, in step c), the optical path control component is configured to refract and direct the lights emitted from the interference pixels toward the areas outside the user area.

12. The method as claimed in claim 10, wherein, in step c), the optical path control component is configured to block optical paths of the lights emitted from the interference pixels toward the user area and to direct the lights emitted from the interference pixels away from the user area and toward the areas outside the user area.

13. The method as claimed in claim 12, wherein the optical path control component is formed with a plurality of light-transmissive parts permitting passage of lights emitted from the display pixels toward the user area, and a plurality of opaque parts blocking passage of the lights emitted from the interference pixels toward the user area, a line connecting one of the interference pixels and a corresponding one of the opaque parts extending to the user area.

14. The method as claimed in claim 13, further comprising configuring the display device to adjust positions of the light-transmissive parts and the opaque parts of the optical path control component according to a position of the user as detected by a detector of the display device.

15. The method as claimed in claim 14, wherein the display device is configured to determine a relative position of the user with respect to the display device via the detector, and to adjust the positions of the light-transmissive parts and the opaque parts of the optical path control component according to the relative position.

16. The method as claimed in claim 9, wherein:
in step b), the display panel of the display device is configured to alternately display the normal image and the interference image; and
in step c), the display device is configured to direct the normal image toward the user area when the display panel displays the normal image, and to direct the interference image toward the areas outside the user area when the display panel displays the interference image such that a viewer situated outside the user area is able to view the interference image.

17. The method as claimed in claim 16, wherein a backlight module of the display device includes a first light source configured to project light such that the normal image is directed at least toward the user area, and a second light source configured to project light such that the interference image is directed toward the areas outside the user area.
